(19) United States
(12) Patent Application Publication
(10) Pub. No.: US 2026/0025771 A1
(43) Pub. Date: Jan. 22, 2026

(54) CALIBRATION OF LP-SS MEASUREMENTS

(71) Applicant: QUALCOMM Incorporated, San Diego, CA (US)

(72) Inventors: Prashant SHARMA, San Marcos, CA (US); Changhwan PARK, San Diego, CA (US); Jae Ho RYU, San Diego, CA (US)

(21) Appl. No.: 18/778,681

(22) Filed: Jul. 19, 2024

(51) Int. Cl. H04W 56/00; H04W 52/02

(52) U.S. Cl. CPC H04W 56/0015; H04W 52/0235; H04W 56/003

(57) ABSTRACT

Calibration of synchronization signal/LP-SS measurements is described. An apparatus is configured to receive, from a network node(s), a calibration configuration indicative of at least one synchronization signal, a threshold condition, a measurement offset, a calibration window, a calibration trigger, and/or a calibration report. The apparatus is configured to receive a synchronization signal(s) and a SSB(s) from the network node(s), respectively. The apparatus is configured to identify a measurement difference between a synchronization signal metric associated with a synchronization signal measurement of the at least one synchronization signal and a SSB metric associated with an SSB measurement of the SSB(s). The apparatus is configured to determine the synchronization signal measurement based on the measurement difference that is associated with a threshold condition. The apparatus is configured to transmit, to the network node(s), the calibration report in accordance with the calibration configuration.

### TECHNICAL FIELD

The present disclosure relates generally to communication systems, and more particularly, to wireless communications utilizing synchronization signaling.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a user equipment (UE). The apparatus is configured to receive at least one synchronization signal and at least one synchronization signal block (SSB) from at least one network node, respectively. The apparatus is configured to identify a measurement difference between a synchronization signal metric associated with a synchronization signal measurement of the at least one synchronization signal and a SSB metric associated with an SSB measurement of the at least one SSB. The apparatus is configured to determine the synchronization signal measurement based on the measurement difference that is associated with a threshold condition.

In the aspect, the method includes receiving at least one synchronization signal and at least one SSB from at least one network node, respectively. The method includes identifying a measurement difference between a synchronization signal metric associated with a synchronization signal measurement of the at least one synchronization signal and a SSB metric associated with an SSB measurement of the at least one SSB. The method includes determining the synchronization signal measurement based on the measurement difference that is associated with a threshold condition.

In another aspect of the disclosure, a method, a computer-readable medium, and an apparatus are provided. The apparatus is configured to configure a UE with a calibration configuration indicative of one or more of at least one synchronization signal, a threshold condition, a measurement offset, a calibration window, a calibration trigger, or a calibration report. The apparatus is configured to transmit, for the UE, the at least one synchronization signal in accordance with the calibration configuration and at least one SSB. The apparatus is configured to receive, from the UE, the calibration report in accordance with the calibration configuration, where the calibration report is indicative of at least one of a measurement difference, a synchronization signal measurement, a synchronization signal metric, an SSB measurement, or an SSB metric, where the measurement difference is between the synchronization signal metric that is associated with the synchronization signal measurement and the SSB metric that is associated with the SSB measurement.

In the aspect, the method includes configuring a UE with a calibration configuration indicative of one or more of at least one synchronization signal, a threshold condition, a measurement offset, a calibration window, a calibration trigger, or a calibration report. The method includes transmitting, for the UE, the at least one synchronization signal in accordance with the calibration configuration and at least one SSB. The method includes receiving, from the UE, the calibration report in accordance with the calibration configuration, where the calibration report is indicative of at least one of a measurement difference, a synchronization signal measurement, a synchronization signal metric, an SSB measurement, or an SSB metric, where the measurement difference is between the synchronization signal metric that is associated with the synchronization signal measurement and the SSB metric that is associated with the SSB measurement.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of low power operation of a UE.

FIG. 5 is a call flow diagram for wireless communications, in accordance with various aspects of the present disclosure.

FIG. 6 is a diagram illustrating examples of calibration of synchronization signal/LP-SS measurements, in accordance with various aspects of the present disclosure.

FIG. 7 is a diagram illustrating examples of calibration of synchronization signal/LP-SS measurements, in accordance with various aspects of the present disclosure.

FIG. 8 is a diagram illustrating examples of calibration of synchronization signal/LP-SS measurements, in accordance with various aspects of the present disclosure.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks may be designed to support communications between network nodes (e.g., base stations, gNBs, etc.)/network entities (e.g., in a core network) and UEs. A UE may include a main radio (MR), e.g., for connected mode operations, as well as a low-power radio (or low-power wake-up radio (LP-WUR)) for low power operations. A LP-WUR may be a simple radio receiver circuit designed to have a very low energy consumption. For instance, when there is no data to receive, the MR may be in an ultra-low power state (ULPS) unless there is something to transmit, while the LP-WUR may actively monitor for low-power wake-up signals (LP-WUSs). When there is data to receive, the LP-WUR may receive a LP-WUS and activate the MR so that data is transmitted and received by the MR. A LP-WUS may be utilized to reduce unnecessary UE paging monitoring. For instance, a LP-WUS may be transmitted when there is paging for idle or inactive mode UEs, and if the LP-WUS is detected, the MR may be turned on, monitoring for a SSB before a paging occasion (PO) for synchronization and then receiving the paging accordingly. If a LP-WUS is not detected, the MR may stay in deep sleep or ULPS mode for power savings without monitoring paging occasions (e.g., the MR may not monitor paging occasions in such low power modes). Low power synchronization signals (LP-SSs) may be transmitted periodically to assist the LP-WUR with time/frequency synchronization.

However, as the UE may also perform measurements for mobility purposes, such as cell-reselection, handover, etc., and the UE cannot save as much power if the MR is frequently awake to perform such radio resource management (RRM) measurements. Current solutions lack conditions for entry to and exit from LP-WUS monitoring and operations of the LP-WUR for improved power savings. Additionally, current solutions lack procedures to relax RRM operations of a UE MR, for both serving and neighbor cell measurements, as well as procedures for UE serving cell RRM measurement to be offloaded from the MR to the LP-WUR of the UE, including the conditions utilized therefor.

Various aspects relate generally to wireless communications utilizing synchronization signaling. Some aspects more specifically relate to calibration of synchronization signal/LP-SS measurements. In some examples, a UE may be configured for calibration of synchronization signal/LP-SS measurements by a network node. The UE may receive an SSB(s) and synchronization signal(s)/LP-SS(s) from a network node (e.g., a serving cell, a neighbor cell, etc.) and identify a measurement difference. The measurement difference may be between a synchronization signal metric associated with a synchronization signal measurement of the synchronization signal(s) and a SSB metric associated with an SSB measurement the SSB(s). The UE may determine (e.g., maintain or update) the synchronization signal measurement based on the measurement difference that is associated with a threshold condition. The UE may also provide a network node with a calibration report associated with calibration measurements.

Particular aspects of the subject matter described in this disclosure can be implemented to realize one or more of the following potential advantages. In some examples, by utilizing a synchronization signal such as a LP-SS for measurement purposes while the MR stays in the deep sleep mode, the described techniques can be used to alleviate the issues noted above. In some examples, by utilizing a low-power radio (e.g., a LP-WUR) of a UE to monitor for synchronization signal(s)/LP-SS(s), the described techniques can be used to offload measurements related to UE mobility with reduced active time of the MR to increase power savings. In some examples, by utilizing entry/exit criteria for a low-power radio (e.g., a LP-WUR) of a UE to perform measurements related to UE mobility, the described techniques can be used to more efficiently enable and perform low-power radio measurements.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

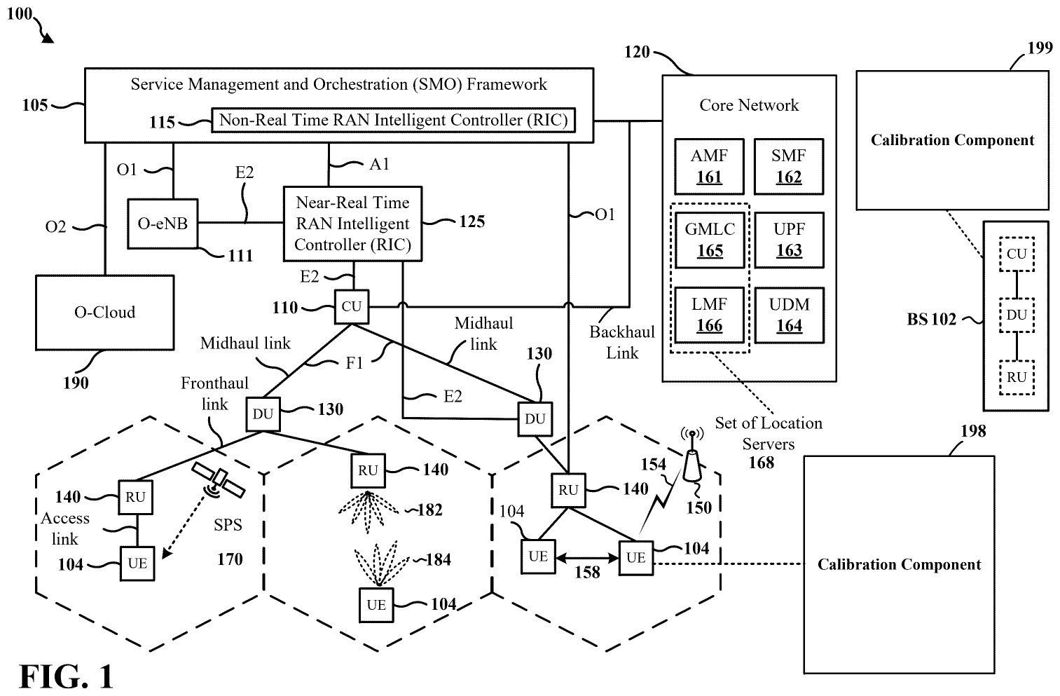

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a calibration component 198 (“component 198”) that may be configured to receive at least one synchronization signal and at least one SSB from at least one network node, respectively. The component 198 may be configured to identify a measurement difference between a synchronization signal metric associated with a synchronization signal measurement of the at least one synchronization signal and a SSB metric associated with an SSB measurement of the at least one SSB. The component 198 may be configured to determine the synchronization signal measurement based on the measurement difference that is associated with a threshold condition. In certain aspects, the base station 102 may have a calibration component 199 (“component 199”) that may be configured to configure a UE with a calibration configuration indicative of one or more of at least one synchronization signal, a threshold condition, a measurement offset, a calibration window, a calibration trigger, or a calibration report. The component 199 may be configured to transmit, for the UE, the at least one synchronization signal in accordance with the calibration configuration and at least one SSB. The component 199 may be configured to receive, from the UE, the calibration report in accordance with the calibration configuration, where the calibration report is indicative of at least one of a measurement difference, a synchronization signal measurement, a synchronization signal metric, an SSB measurement, or an SSB metric, where the measurement difference is between the synchronization signal metric that is associated with the synchronization signal measurement and the SSB metric that is associated with the SSB measurement. Accordingly, aspects herein for calibration of synchronization signal/LP-SS measurements utilize synchronization signals such as LP-SSs for measurement purposes while a MR stays in a deep sleep mode. Aspects provide for offloading measurements related to UE mobility with reduced active time of the MR to increase power savings by utilizing a low-power radio (e.g., a LP-WUR) of a UE to monitor for synchronization signal(s)/LP-SS(s), and aspects more efficiently enable and perform low-power radio measurements by utilizing entry/exit criteria for a low-power radio (e.g., a LP-WUR) of a UE to perform measurements related to UE mobility.

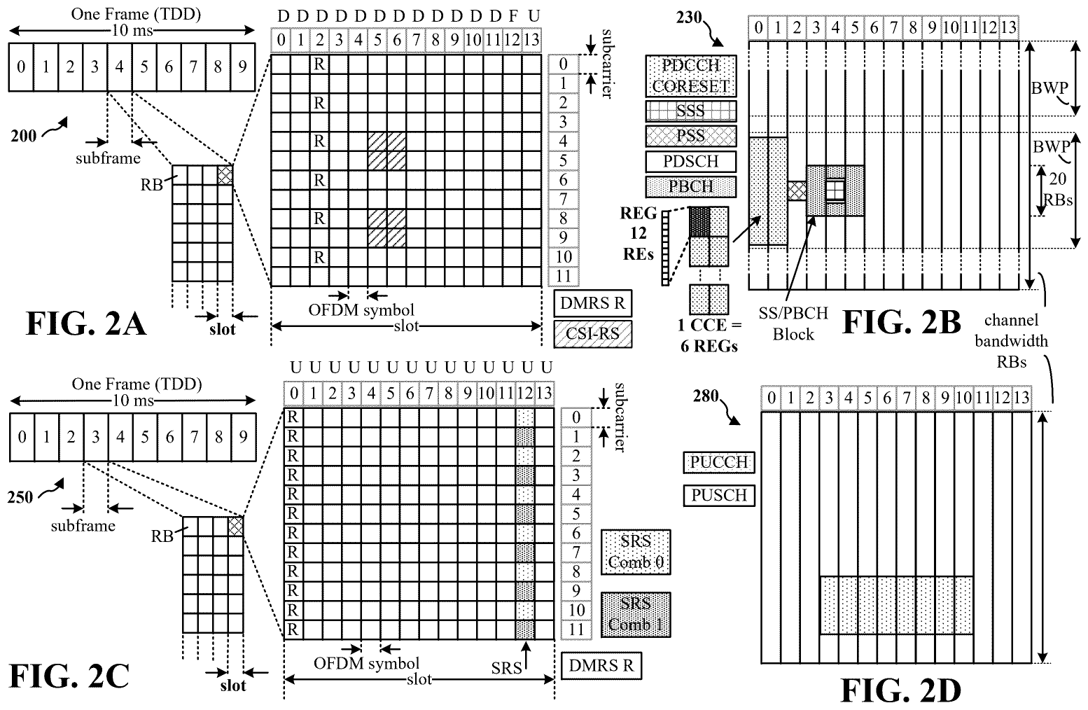

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

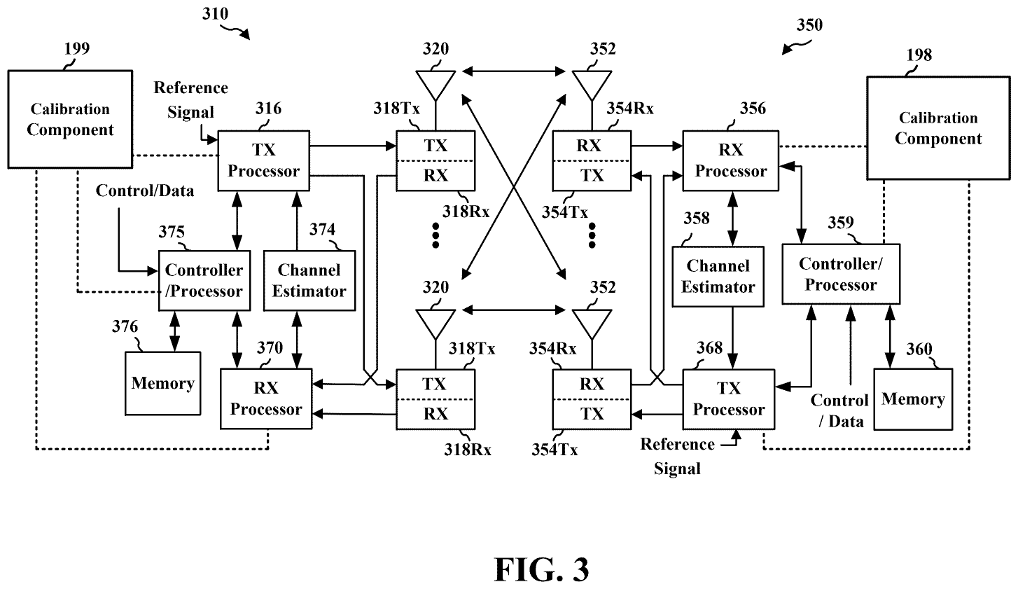

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

As noted herein, a UE may include a MR, e.g., for connected mode operations, as well as a low-power radio (or LP-WUR) for low power operations. A LP-WUR may be a simple radio receiver circuit designed to have a very low energy consumption.

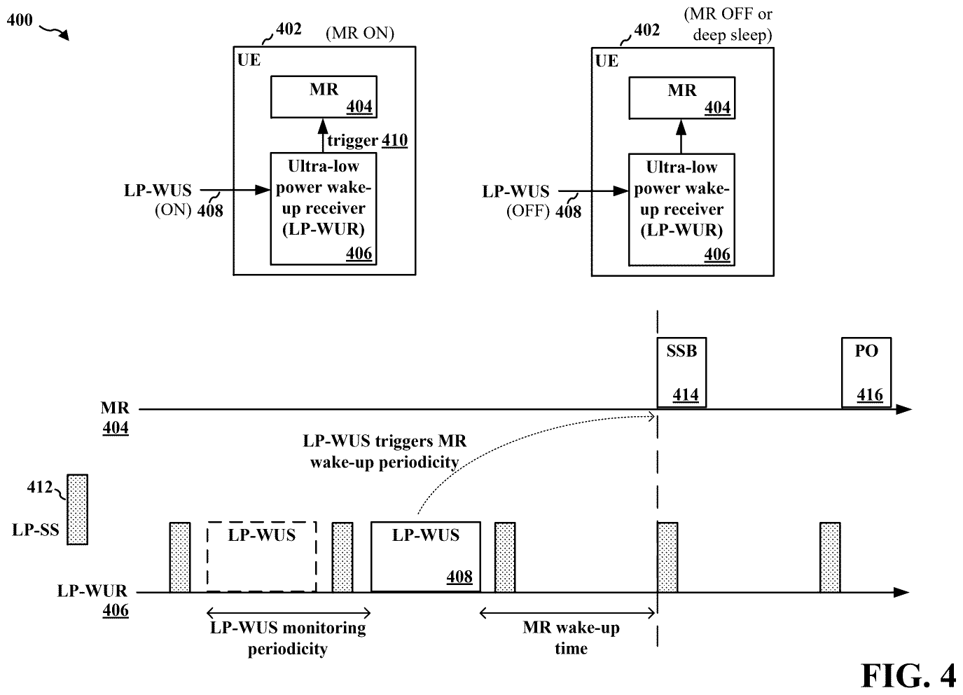

FIG. 4 is a diagram 400 illustrating an example of low power operation of a UE 402. The UE 402 includes a MR 404 and an ultra-low power wake-up receiver (e.g., a LP-WUR 406). A LP-WUS 408 may be detected by the LP-WUR 406 to turn on the MR 404 via a trigger 410. Conversely, a lack of the LP-WUS 408 and/or a timer or other mechanism may cause the MR 404 to turn off or enter a sleep mode. For instance, when there is no data to receive, the MR 404 may be in a ULPS unless there is something to transmit, while the LP-WUR 406 may actively monitor for the LP-WUS 408 with a LP-WUS monitoring periodicity. When there is data to receive, the LP-WUR 406 may receive the LP-WUS 408 and activate the MR 404 so that data is transmitted and received by the MR 404. Accordingly, the LP-WUS 408 may be utilized to reduce unnecessary paging receptions for the UE 402. For instance, the LP-WUS 408 may be transmitted when there is paging for idle or inactive mode UEs, and if the LP-WUS 408 is detected, the MR 404 may be turned on after a wake-up time, monitoring for a SSB 414 before a PO 416 for synchronization and then receiving the paging accordingly. If the LP-WUS 408 is not detected, the MR 404 may stay in deep sleep or ULPS mode for power savings. Instances of LP-SSs 412 may be transmitted periodically to assist the LP-WUR 406 with time/frequency synchronization. The LP-WUR 406 may be configured to monitor LP-SS 412 instances.

However, as UEs may also perform measurements for mobility purposes, such as cell-reselection, handover, etc., and UEs cannot save as much power if their MR is frequently awake to perform such RRM measurements. Current solutions lack conditions for entry to and exit from LP-WUS monitoring and operations of the LP-WUR for improved power savings. Additionally, current solutions lack procedures to relax RRM operations of a UE MR, for both serving and neighbor cell measurements, as well as procedures for UE serving cell RRM measurement to be offloaded from the MR to the LP-WUR of the UE, including the conditions utilized therefor.

Aspects herein are related to procedures and operations of UE radios, such as MRs and LP-WURs, including RRM measurement relaxations and measurement offloading to LP-WUR. For idle/inactive modes, aspects herein provide for a LP-WUS of a UE to indicate paging monitoring triggered by a LP-WUS, including configuration, sub-grouping, and entry/exit conditions for LP-WUS monitoring. a LP-SS may have a periodicity (e.g., in ms) for a LP-WUR, for synchronization, and/or RRM for a serving cell. LP-SS may be based on on-off keying (OOK), such as OOK-1 and/or OOK-4 waveforms, with or without overlaid OFDM sequences. In some aspects, for LP-WUR configured to receive existing PSS/SSS, the existing PSS/SSS may be used for synchronization and RRM in addition to, or in lieu of, LP-SS. Aspects include RRM relaxation of a UE MR for both serving and neighbor cell measurements, as well as UE serving cell RRM measurement offloading from a MR to a LP-WUR, including the associated conditions such as entry/exit. Aspects include performance of serving cell and neighbor cell measurements for cell reselection purposes in which offloading of some measurements from the MR to the LP-WUR is performed to achieve UE power savings. That is, the LP-WUR may perform at least a portion of these measurements on the LP-SS resources and/or the like, and entry/exit conditions may be defined for when the LP-WUR may perform the measurements instead of the MR. In some aspects, the LP-WUR may also perform cell reselection criteria evaluation or measurement offloading/relaxation and/or entry/exit criteria evaluation. In some scenarios, there may be discrepancies between LP-SS based and SSB based measurements. For instance, the LP-SS may be configured outside of the MR active bandwidth part, implying that the LP-SS and SSB may be well separated in frequency and hence undergo different channel profiles. Additionally, a separate Rx chain for the LP-WUR may lead to further discrepancies in the measurements, and such discrepancies may vary over time depending on the time/frequency drift of the LP-WUR and/or varying channel profiles. As the MR may not perform some or all of the RRM measurements, the reliability of the LP-SS based measurements should be ensured to achieve similar system performance as compared to MR-based measurements. Accordingly, aspects provide for calibration mechanisms and procedures to ensure that LP-SS measurements are comparable to the SSB based measurements. While measurement relaxations and offloading may be described as taking place during the idle/inactive mode, it may also be further extended to the connected mode, in various aspects.

A calibration mechanism for LP-SS is proposed, in accordance with aspects herein. Aspects provided herein for calibration of synchronization signal/LP-SS measurements may alleviate the issues noted above by utilizing a synchronization signal, such as a LP-SS for measurement purposes, while the MR stays in a deep sleep mode. Aspects provided herein may also offload measurements related to UE mobility with reduced active time of the MR to increase power savings by utilizing a low-power radio (e.g., a LP-WUR) of a UE to monitor for synchronization signal(s)/LP-SS(s). Aspects provided herein may also more efficiently enable and perform low-power radio measurements by utilizing entry/exit criteria for a low-power radio (e.g., a LP-WUR) of a UE to perform measurements related to UE mobility.

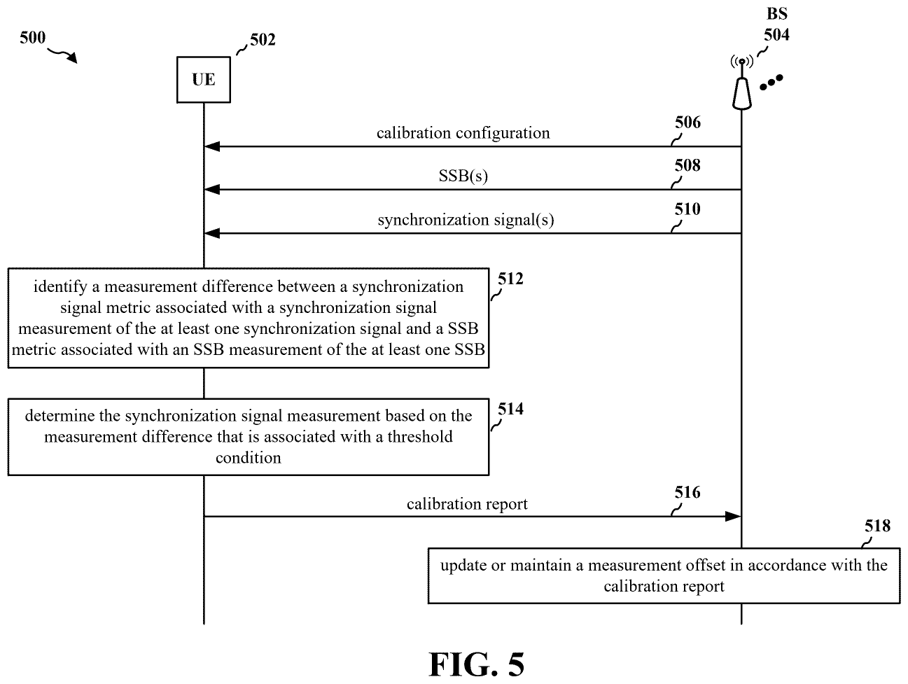

FIG. 5 is a call flow diagram 500 for wireless communications, in various aspects. Call flow diagram 500 illustrates calibration of synchronization signal/LP-SS measurements for a UE (e.g., a UE 502), by way of example, that communicates with a network node (e.g., a base station 504, a gNB, etc. (which may be a serving and/or neighbor cell), as shown and described herein), by way of example. While call flow diagram 500 is illustrated and described with respect to a base station, aspects include that the base station 504 may be two or more base stations such as for a serving and neighbor cell(s). Aspects described for base stations, and for network nodes/entities herein, generally, may be performed in aggregated form and/or by one or more components in disaggregated form. Additionally, or alternatively, the aspects may be performed by a UE autonomously, in addition to, and/or in lieu of, operations of a network node/base station.

In the illustrated aspect, the UE 502 may be configured to receive, and the base station 504 may be configured to transmit/provide, a calibration configuration 506 indicative of one or more of at least one synchronization signal 510, a threshold condition, a measurement offset, a calibration window, a calibration trigger, or a calibration report 516. In aspects, the calibration configuration 506 may be received and/or transmitted/provided, via at least one of system information (SI) or RRC signaling.

In aspects, the calibration window (i) may be associated with at least one of a frequency separation, a frequency band, a frequency range, or a signal periodicity of the at least one synchronization signal 510 and at least one SSB 508, and (ii) may define a period of time, and/or a start time thereof, associated with the at least one SSB 508 for reception of the at least one synchronization signal 510.

In aspects, as noted above, the calibration configuration 506 may be indicative of the calibration report 516. The calibration report 516 may be indicative of at least one of a measurement difference, an estimated calibration error that is based on the measurement difference, a synchronization signal measurement, a synchronization signal metric, a SSB measurement, or a SSB metric. A synchronization signal metric and/or a SSB metric may be at least one of a reference signal received power (RSRP), a reference signal received quality (RSRQ), or a signal to interference and noise ratio (SINR). In some aspects, the calibration configuration 506 may be indicative of the calibration report 516 being based on at least one of a periodic reporting, a connected mode reporting, or a reporting threshold condition associated with an estimated calibration error that is based on the measurement difference. In aspects, the measurement offset may be based on a prior instance of the calibration report 516.

The calibration trigger may be based on at least one trigger type, as described below. In one example, the calibration trigger may be a periodic calibration trigger associated with a periodicity during which identification of the measurement difference and determination of the synchronization signal measurement are performed at least one time. As another example, the calibration trigger may be a timer-based calibration trigger associated with a timer at an expiration of which the identification of the measurement difference and the determination of the synchronization signal measurement are performed, where a reset of the timer may be based on a wake up associated with the UE 502 when the timer is active. As a further example, the calibration trigger may be an indication-based calibration trigger associated with a wake-up signal indication, where the SSB measurement may be associated with the UE 502 being in a connected mode.

The UE 502 may be configured to receive, and the base station 504 may be configured to transmit/provide, the at least one SSB 508. In aspects, the UE 502 may be configured to receive the at least one SSB 508 from the at least one network node (e.g., the base station 504 and another base station, where the at least one network node may be a serving cell and/or a neighbor cell(s)) via a second radio of the UE 502, such as a MR of the UE 502. The UE 502 may be configured to receive, and the base station 504 may be configured to transmit/provide, at least one synchronization signal 510. That is, the UE 502 may be configured to receive at least one synchronization signal 510 from at least one network node (e.g., the base station 504 and another base station), respectively, where the at least one network node may be a serving cell and/or a neighbor cell(s). The UE 502 may be configured to receive the at least one synchronization signal 510 from the at least one network node (e.g., the base station 504 and another base station, where the at least one network node may be a serving cell and/or a neighbor cell(s)) via a first radio of the UE 502, such as a low-power radio or a LP-WUR of the UE 502. The at least one synchronization signal 510 may include at least one LP-SS, PSS, SSS, SSB, and/or the like. In aspects, the UE 502 may be configured to receive the at least one synchronization signal 510 during a calibration window having a start time and a period, in accordance with the calibration configuration 506 and/or a calibration report trigger(s).

The UE 502 may be configured to identify (at 512) the measurement difference between the synchronization signal metric that may be associated with the synchronization signal measurement of the at least one synchronization signal 510 and the SSB metric that may be associated with the SSB measurement of the at least one SSB 508. For example, to identify (at 512) the measurement difference, the UE 502 may be configured to measure the at least one synchronization signal 510 and to obtain the synchronization signal measurement for the synchronization signal metric based on the at least one synchronization signal 510 that is measured. Accordingly, the UE 502 may be configured to identify (at 512) the measurement difference based on the obtained synchronization signal measurement.

The UE 502 may be configured to determine (at 514) the synchronization signal measurement based on the measurement difference that is associated with the threshold condition. As used herein, to determine by a UE may mean to configure by the UE, to set by the UE, and/or the like. For example, the UE 502 may be configured to estimate a calibration error based on the measurement difference, and to update or maintain the synchronization signal measurement as an updated/maintained synchronization signal measurement in accordance with the estimated calibration error. In aspects, the threshold condition may be associated with at least one of a first comparison of a first difference between the synchronization signal metric and the SSB metric with a threshold instance value, or a second comparison of a second difference between a first mean value of the synchronization signal metric and a second mean value of the SSB metric with a mean threshold value. In some aspects, at least one of the threshold instance value or the mean threshold value may include an addition of the measurement offset.

The UE 502 may be configured to transmit/provide, and the base station 504 (e.g., at least one network node) may be configured to receive, the calibration report 516 in accordance with the calibration configuration 506. The calibration report 516 may be indicative of at least one of the measurement difference, the estimated calibration error that is based on the measurement difference, the synchronization signal measurement, the synchronization signal metric, the SSB measurement, or the SSB metric. The base station 504 may be configured to update or maintain (at 518) the measurement offset in accordance with the calibration report 516, which may be indicated to the UE 502.

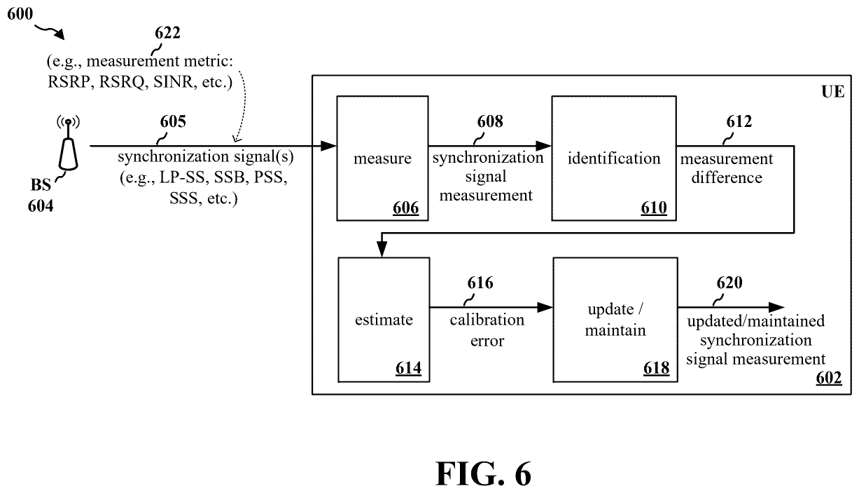

FIG. 6 is a diagram 600 illustrating examples of calibration of synchronization signal/LP-SS measurements, in various aspects. Diagram 600 may be an aspect of call flow diagram 500 in FIG. 5, and is shown in the context of a UE 602 that may communicate with a network node (e.g., a base station 604, a gNB, etc.).

The UE 602 may be configured to receive one or more instances of a synchronization signal 605 from the base station 604. The UE 602 may be configured to perform calibrations of measurements to ensure that the difference between synchronization signal/LP-SS based measurements/SSB based measurements (M_{WUR}) by a LP-WUR (as described herein) and corresponding SSB based measurements (M_{MR}) by a MR (as described herein) is less than a threshold condition associated with a threshold (T).

For instance, the UE 602 may be configured to measure (at 606) at least one instance of the synchronization signal 605 and obtain a synchronization signal measurement 608 for the synchronization signal metric (e.g., the measurement metric 622, such as RSRP, RSRQ, SINR, etc.) based on at least one of the synchronization signal 605 that is measured (at 606). The UE 602 may be configured to identify (at 610) a measurement difference 612 based on the synchronization signal measurement 608 that is obtained (at 610).

The UE 602 may be configured to estimate (at 614) a calibration error 616 based on the measurement difference 612. The UE 602 may be further configured to update or maintain (at 618) the synchronization signal measurement 608 as an updated/maintained synchronization signal measurement 620 in accordance with the calibration error 616 that is estimated (at 614). As one example, the UE 602 may be configured to estimate (at 614) the calibration error 616, M_{CAL}, and to update/maintain (at 618) the LP-WUR measurements as M_{WUR}=M_{WUR}+M_{CAL}.

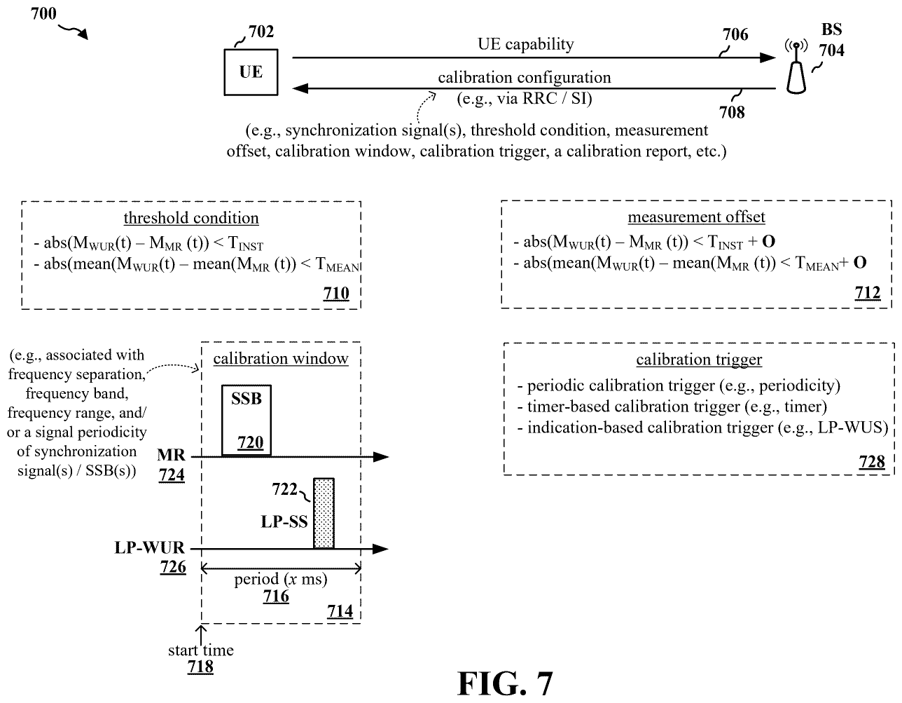

FIG. 7 is a diagram 700 illustrating examples of calibration of synchronization signal/LP-SS measurements, in various aspects. Diagram 700 may be an aspect of call flow diagram 500 in FIG. 5, and is shown in the context of a UE 702 that may communicate with a network node (e.g., a base station 704, a gNB, etc.).

As noted herein, the UE 702 may be configured to receive one or more instances of a synchronization signal from the base station 704. The UE 702 may be configured to perform calibrations of measurements to ensure that the difference between synchronization signal/LP-SS based measurements/SSB based measurements (M_{WUR}) by a LP-WUR 726 (e.g., a first radio of the UE 702, as described herein) and corresponding SSB based measurements (M_{MR}) by a MR 724 (a second radio of the UE 702, as described herein) is less than a threshold condition 710 associated with a threshold (T).

In aspects, the UE 702 may be configured to receive, and the base station 704 may be configured to transmit/provide, a calibration configuration 708 (e.g., via SI or RRC signaling). In some aspects, the calibration configuration 708 may be associated with, or based at least in part on, a UE capability 706 of the UE 702 that may be provided to the base station 704. The calibration configuration 708 may be indicative of one or more of at least one synchronization signal (as described herein), the threshold condition 710, a measurement offset 712, a calibration window 714, a calibration trigger 728, a calibration report, and/or the like.

The threshold condition 710 may be a first comparison of a first difference between a synchronization signal metric and a SSB metric with a threshold instance value, e.g., abs(M_{WUR}(t)−M_{MR}(t))<T_{INST}, and/or may be a second comparison of a second difference between a first mean value of a synchronization signal metric and a second mean value of a SSB metric with a mean threshold value, e.g., abs(mean (M_{WUR}(t)−mean(M_{MR}(t))<T_{MEAN}. In some aspects, M_{WUR} and/or M_{MR} may be a measurement metric (e.g., the measurement metric 622 in FIG. 6) such as RSRP, RSRQ, SINR, etc. The threshold instance values T_{INST} and T_{MEAN} may be pre-defined as standard values for the UE 702; additionally, or alternatively, T_{INST} and T_{MEAN} may be configured (e.g., semi-statically) by the network, e.g., via SI or RRC signaling from the base station 704. In such aspects, when the base station 704 configures T_{INST} and T_{MEAN}, the configured value(s) from the base station 704 may override the value(s) that is pre-defined.

In some aspects, the base station 704 may configure a measurement offset (O) 712 to be applied to the synchronization signal measurements to compare with SSB based measurements, as described herein. In such cases, the difference between the measurements is less than the measurement offset 712 that is configured: O+threshold (T_{INST} and/or T_{MEAN}). Accordingly, the threshold condition 710 may be modified as abs(M_{WUR}−M_{MR})<T_{INST}+O and/or as abs(mean (M_{WUR}(t)−mean (M_{MR}(t))<T_{MEAN}+O.

As described herein, the base station 704 may configure dedicated measurement resources (e.g., synchronization signals, such as an LP-SS 722 received by the LP-WUR 726 and/or a SSB 720 received by the MR 724, etc.) for calibration via the calibration configuration 708. The base station 704 may configure such calibration resources within a defined time window, such as the calibration window 714. The calibration window 714 may be defined such that the resources/synchronization signals (e.g., the LP-SS 722 and/or the SSB 720, etc.) for the calibration are not apart from each other by more than x ms to ensure the measurements are correlated. As one example, the calibration window 714 may have a length or a period 716 in which the LP-SS 722 and the SSB 720 are received by the UE 702. The length/the period 716, and a start time 718, of the calibration window 714 may be differently configured/applied depending on the frequency separation, the frequency band, the frequency range, and/or the periodicities of the resources (e.g., the LP-SS 722 and/or the SSB 720, etc.), according to aspects.

As described herein, a UE such as the UE 702 may be configured to perform calibration of synchronization signal/LP-SS measurements, and in aspects, such performance may be associated with the calibration trigger 728, which may be configured by the base station 704 as being periodic, timer-based, or indication-based (e.g., explicit). As one example, the calibration trigger 728 may be a periodic calibration trigger associated with a periodicity during which identification of the measurement difference and determination of the synchronization signal measurement are performed at least one time by the UE 702. As another example, the calibration trigger 728 may be a timer-based calibration trigger associated with a timer at an expiration of which the identification of the measurement difference and the determination of the synchronization signal measurement are performed, where a reset of the timer is based on a wake up associated with the UE 702 when the timer is active. As a further example, the calibration trigger 728 may be an indication-based calibration trigger associated with a wake-up signal indication (e.g., a LP-WUS), where the SSB measurement is associated with the UE 702 being in a connected mode.

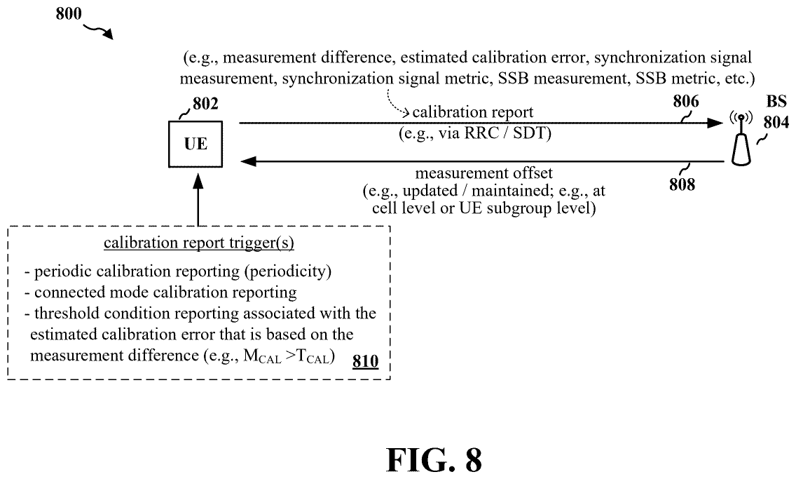

FIG. 8 is a diagram 800 illustrating examples of calibration of synchronization signal/LP-SS measurements, in various aspects. Diagram 800 may be an aspect of call flow diagram 500 in FIG. 5, and is shown in the context of a UE 802 that may communicate with a network node (e.g., a base station 804, a gNB, etc.). As noted above, a calibration configuration may be indicative of a calibration report, such as a calibration report 806, shown in diagram 800, which the UE 802 may be configured to transmit/provide and the base station 804 may be configured to receive (e.g., via RRC signaling, a small data transmission (SDT) procedure(s), etc.).

In aspects, the calibration report 806 may be indicative of calibration measurements and data described herein, such as but without limitation, the measurement difference between a synchronization signal metric associated with a synchronization signal measurement of the at least one synchronization signal and a SSB metric associated with an SSB measurement of at least one SSB, the estimated calibration error that is based on the measurement difference, the synchronization signal measurement, the synchronization signal metric, the SSB measurement, or the SSB metric.

In aspects, at least one calibration report trigger(s) 810 may be indicated in the calibration configuration, and may serve as a basis for when/how often the UE 802 transmits/provides the calibration report 806 to the base station 804. As examples, the calibration configuration may be indicative of one or more of the calibration report trigger(s) 810 for the calibration report 806 as being based a periodic reporting, a connected mode reporting, or a reporting threshold condition associated with the estimated calibration error that is based on the measurement difference.

In aspects, the UE 802 may be configured to transmit/provide the calibration report 806 values periodically. In one example for periodic reporting, the UE 802 may be in an idle/inactive mode and may wake up its MR and switch to a RRC connected mode periodically. In another example for periodic reporting, the UE 802 may be in an inactive mode (e.g., sleep, deep sleep, ULPS, etc., depending on the UE 802 capability), and the UE 802 may be configured to provide/transmit the calibration report 806 values using a SDT procedure(s).

In aspects, the UE 802 may be configured to transmit/provide the calibration report 806 values when in a connected mode. For instance, the UE 802 may be configured to store the calibration values for the calibration report 806, and to subsequently transmit/provide the calibration report 806 values when the UE 802 switches to the connected mode.

In aspects, the UE 802 may be configured to transmit/provide the calibration report 806 values based on a reporting threshold condition. For instance, the UE 802 may be configured to transmit/provide the calibration report 806 values in association with on an event-trigger as the reporting threshold condition, e.g., a calibration value(s) exceeds a configured threshold (e.g., M_{CAL}>T_{CAL}). That is, the UE 802 may determine (such as in accordance with a periodicity, when measurements are performed, etc.) if the calibration values that are measured (M_{CAL}) meet a condition associated with a configured threshold (T_{CAL}). In such aspects, the UE 802 may be configured to transmit/provide the calibration report 806 to the base station 804 via RRC signaling, a SDT procedure(s), etc.

The base station 804 may be configured to utilize values/information included with or indicated by the calibration report 806 to further fine-tune (e.g., update) or maintain the LP-SS to SSB measurement offset (e.g., the measurement offset 712 (O) in FIG. 7). In aspects, the base station 804 may indicate the maintained or updated measurement offset (O) 808 to the UE 802 (e.g., via a subsequent instance of calibration configuration), which may be either on a cell level or a UE subgroup level.

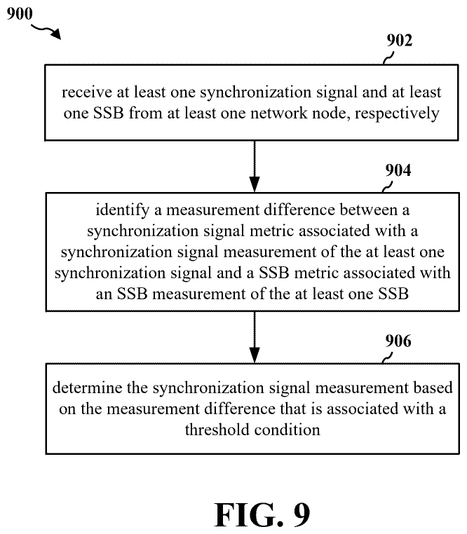

FIG. 9 is a flowchart 900 of a method of wireless communication. The method may be performed by a UE (e.g., the UE 104, 402, 502, 602, 702, 802; the apparatus 1104). In some aspects, the method may include aspects described in connection with the communication flow in FIG. 5, and/or aspects described in FIGS. 4, 6, 7, 8. The method may be for calibration of synchronization signal/LP-SS measurements to utilize the synchronization signals, such as LP-SSs, for measurement purposes while a MR stays in a deep sleep mode. The method may provide for offloading measurements related to UE mobility with reduced active time of the MR to increase power savings by utilizing a low-power radio (e.g., a LP-WUR) of a UE to monitor for synchronization signal(s)/LP-SS(s), and for more efficiently enabling and performing low-power radio measurements by utilizing entry/exit criteria for a low-power radio (e.g., a LP-WUR) of a UE to perform measurements related to UE mobility.

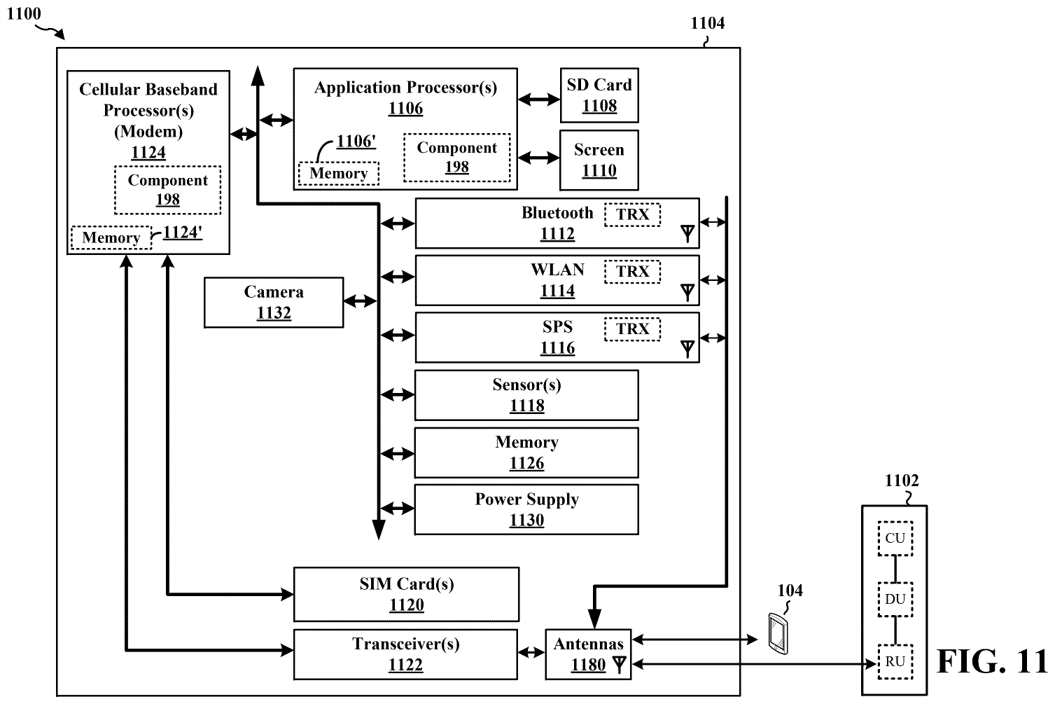

At 902, the UE receives at least one synchronization signal and at least one SSB from at least one network node, respectively. For example, the reception may be performed by one or more of the component 198, the transceiver(s) 1122, and/or the antenna 1180 in FIG. 11. FIG. 5 illustrates, in the context of FIGS. 6, 7, 8, an example of the UE 502 receiving such a synchronization signal(s) from at least one network node (e.g., the base station 504).

The UE 502 may be configured to receive, and the base station 504 may be configured to transmit/provide, a calibration configuration 506 (e.g., 708 in FIG. 7) indicative of one or more of at least one synchronization signal 510 (e.g., 605 in FIG. 6; 722 in FIG. 7), a threshold condition (e.g., 710 in FIG. 7), a measurement offset (e.g., 712 in FIG. 7; 808 in FIG. 8), a calibration window (e.g., 714 in FIG. 7), a calibration trigger (e.g., 728 in FIG. 7), or a calibration report 516 (e.g., 806 in FIG. 8). In aspects, the calibration configuration 506 (e.g., 708 in FIG. 7) may be received and/or transmitted/provided, via at least one of SI or RRC signaling. In aspects, the calibration window (e.g., 714 in FIG. 7) (i) may be associated with at least one of a frequency separation, a frequency band, a frequency range, or a signal periodicity of the at least one synchronization signal 510 (e.g., 605 in FIG. 6; 722 in FIG. 7) and at least one SSB 508 (e.g., 605 in FIG. 6; 720 in FIG. 7), and (ii) may define a period of time (e.g., 716 in FIG. 7), and/or a start time (e.g., 718 in FIG. 7) thereof, associated with the at least one SSB 508 (e.g., 605 in FIG. 6; 720 in FIG. 7) for reception of the at least one synchronization signal 510 (e.g., 605 in FIG. 6; 722 in FIG. 7). In aspects, as noted above, the calibration configuration 506 (e.g., 708 in FIG. 7) may be indicative of the calibration report 516 (e.g., 806 in FIG. 8). The calibration report 516 (e.g., 806 in FIG. 8) may be indicative of at least one of a measurement difference (e.g., 612 in FIG. 6), an estimated calibration error (e.g., 616 in FIG. 6) that is based on the measurement difference (e.g., 612 in FIG. 6), a synchronization signal measurement (e.g., 608 in FIG. 6), a synchronization signal metric (e.g., 622 in FIG. 6), a SSB measurement (e.g., 608 in FIG. 6), or a SSB metric (e.g., 622 in FIG. 6). A synchronization signal metric (e.g., 622 in FIG. 6) and/or a SSB metric (e.g., 622 in FIG. 6) may be at least one of a reference signal received power (RSRP), a reference signal received quality (RSRQ), or a signal to interference and noise ratio (SINR). In some aspects, the calibration configuration 506 (e.g., 708 in FIG. 7) may be indicative of the calibration report 516 (e.g., 806 in FIG. 8) being based on at least one of a periodic reporting, a connected mode reporting, or a reporting threshold condition associated with an estimated calibration error (e.g., 616 in FIG. 6) that is based on the measurement difference (e.g., 612 in FIG. 6). In aspects, the measurement offset (e.g., 712 in FIG. 7; 808 in FIG. 8) may be based on a prior instance of the calibration report 516 (e.g., 806 in FIG. 8). The calibration trigger (e.g., 728 in FIG. 7) may be based on at least one trigger type, as described below. In one example, the calibration trigger (e.g., 728 in FIG. 7) may be a periodic calibration trigger associated with a periodicity during which identification (e.g., at 610 in FIG. 6) of the measurement difference (e.g., 612 in FIG. 6) and determination of the synchronization signal measurement (e.g., 608 in FIG. 6) are performed at least one time. As another example, the calibration trigger (e.g., 728 in FIG. 7) may be a timer-based calibration trigger associated with a timer at an expiration of which the identification (e.g., at 610 in FIG. 6) of the measurement difference (e.g., 612 in FIG. 6) and the determination of the synchronization signal measurement (e.g., 608 in FIG. 6) are performed, where a reset of the timer may be based on a wake up associated with the UE 502 when the timer is active. As a further example, the calibration trigger (e.g., 728 in FIG. 7) may be an indication-based calibration trigger associated with a wake-up signal indication, where the SSB measurement (e.g., 608 in FIG. 6) may be associated with the UE 502 being in a connected mode. The UE 502 may be configured to receive, and the base station 504 may be configured to transmit/provide, the at least one SSB 508 (e.g., 605 in FIG. 6; 720 in FIG. 7). In aspects, the UE 502 may be configured to receive the at least one SSB 508 (e.g., 605 in FIG. 6; 720 in FIG. 7) from the at least one network node (e.g., the base station 504 and another base station, where the at least one network node may be a serving cell and/or a neighbor cell(s)) via a second radio of the UE 502, such as a MR (e.g., at 724 in FIG. 7) of the UE 502. The UE 502 may be configured to receive, and the base station 504 may be configured to transmit/provide, at least one synchronization signal 510 (e.g., 605 in FIG. 6; 722 in FIG. 7). That is, the UE 502 may be configured to receive at least one synchronization signal 510 (e.g., 605 in FIG. 6; 722 in FIG. 7) from at least one network node (e.g., the base station 504 and another base station), respectively, where the at least one network node may be a serving cell and/or a neighbor cell(s). The UE 502 may be configured to receive the at least one synchronization signal 510 (e.g., 605 in FIG. 6; 722 in FIG. 7) from the at least one network node (e.g., the base station 504 and another base station, where the at least one network node may be a serving cell and/or a neighbor cell(s)) via a first radio of the UE 502, such as a low-power radio or a LP-WUR (e.g., at 726 in FIG. 7) of the UE 502. The at least one synchronization signal 510 (e.g., 605 in FIG. 6; 722 in FIG. 7) may include at least one LP-SS, PSS, SSS, SSB, and/or the like. In aspects, the UE 502 may be configured to receive the at least one synchronization signal 510 (e.g., 605 in FIG. 6; 722 in FIG. 7) during a calibration window (e.g., 714 in FIG. 7) having a start time (e.g., 718 in FIG. 7) and a period (e.g., 716 in FIG. 7), in accordance with the calibration configuration 506 (e.g., 708 in FIG. 7).

At 904, the UE identifies a measurement difference between a synchronization signal metric associated with a synchronization signal measurement of the at least one synchronization signal and a SSB metric associated with an SSB measurement of the at least one SSB. For example, the identification may be performed by one or more of the component 198, the transceiver(s) 1122, and/or the antenna 1180 in FIG. 11. FIG. 5 illustrates, in the context of FIGS. 6, 7, 8, an example of the UE 502 identifying such a measurement difference.

The UE 502 may be configured to identify (at 512) (e.g., at 610 in FIG. 6) the measurement difference (e.g., 612 in FIG. 6) between the synchronization signal metric (e.g., 622 in FIG. 6) that may be associated with the synchronization signal measurement (e.g., 608 in FIG. 6) of the at least one synchronization signal 510 (e.g., 605 in FIG. 6; 722 in FIG. 7) and the SSB metric (e.g., 622 in FIG. 6) that may be associated with the SSB measurement (e.g., 608 in FIG. 6) of the at least one SSB 508 (e.g., 605 in FIG. 6; 720 in FIG. 7). For example, to identify (at 512) (e.g., at 610 in FIG. 6) the measurement difference (e.g., 612 in FIG. 6), the UE 502 may be configured to measure (e.g., at 606 in FIG. 6) the at least one synchronization signal 510 (e.g., 605 in FIG. 6; 722 in FIG. 7) and to obtain the synchronization signal measurement (e.g., 608 in FIG. 6) for the synchronization signal metric (e.g., 622 in FIG. 6) based on the at least one synchronization signal 510 (e.g., 605 in FIG. 6; 722 in FIG. 7) that is measured (e.g., at 606 in FIG. 6). Accordingly, the UE 502 may be configured to identify (at 512) (e.g., at 610 in FIG. 6) the measurement difference (e.g., 612 in FIG. 6) based on the obtained synchronization signal measurement (e.g., 608 in FIG. 6).

At 906, the UE determines the synchronization signal measurement based on the measurement difference that is associated with a threshold condition. For example, the determination may be performed by one or more of the component 198, the transceiver(s) 1122, and/or the antenna 1180 in FIG. 11. FIG. 5 illustrates, in the context of FIGS. 6, 7, 8, an example of the UE 502 determining such a synchronization signal measurement.

The UE 502 may be configured to determine (at 514) the synchronization signal measurement (e.g., 608 in FIG. 6) based on the measurement difference (e.g., 612 in FIG. 6) that is associated with the threshold condition (e.g., 710 in FIG. 7). As used herein, to determine by a UE may mean to configure by the UE, to set by the UE, and/or the like. For example, the UE 502 may be configured to estimate (e.g., at 614 in FIG. 6) as an updated/maintained synchronization signal measurement a calibration error based on the measurement difference (e.g., 612 in FIG. 6), and to update or maintain (e.g., at 618 in FIG. 6) the synchronization signal measurement (e.g., 608 in FIG. 6) as an updated/maintained synchronization signal measurement (e.g., 620 in FIG. 6) in accordance with the estimated calibration error (e.g., 616 in FIG. 6). In aspects, the threshold condition (e.g., 710 in FIG. 7) may be associated with at least one of a first comparison of a first difference between the synchronization signal metric (e.g., 622 in FIG. 6) and the SSB metric (e.g., 622 in FIG. 6) with a threshold instance value, or a second comparison of a second difference between a first mean value of the synchronization signal metric (e.g., 622 in FIG. 6) and a second mean value of the SSB metric (e.g., 622 in FIG. 6) with a mean threshold value. In some aspects, at least one of the threshold instance value or the mean threshold value may include an addition of the measurement offset (e.g., 712 in FIG. 7; 808 in FIG. 8). The UE 502 may be configured to transmit/provide, and the base station 504 (e.g., at least one network node) may be configured to receive, the calibration report 516 (e.g., 806 in FIG. 8) in accordance with the calibration configuration 506 (e.g., 708 in FIG. 7) and/or a calibration report trigger(s) (e.g., 810 in FIG. 8). The calibration report 516 (e.g., 806 in FIG. 8) may be indicative of at least one of the measurement difference (e.g., 612 in FIG. 6), the estimated calibration error (e.g., 616 in FIG. 6) that is based on the measurement difference (e.g., 612 in FIG. 6), the synchronization signal measurement (e.g., 608 in FIG. 6), the synchronization signal metric (e.g., 622 in FIG. 6), the SSB measurement (e.g., 608 in FIG. 6), or the SSB metric (e.g., 622 in FIG. 6). The base station 504 may be configured to update or maintain (at 518) the measurement offset (e.g., 712 in FIG. 7; 808 in FIG. 8) in accordance with the calibration report 516 (e.g., 806 in FIG. 8), which may be indicated to the UE 502.

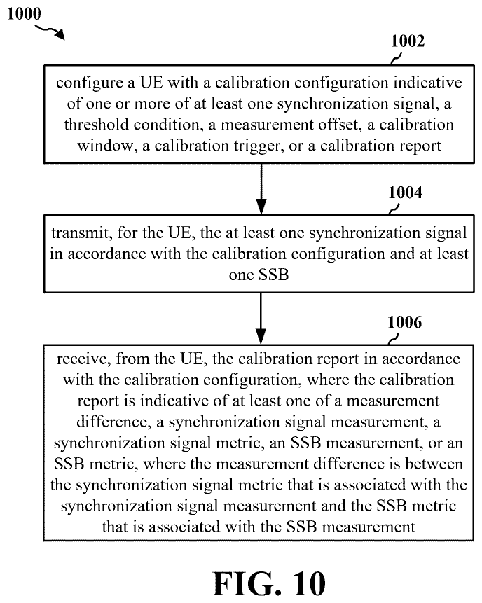

FIG. 10 is a flowchart 1000 of a method of wireless communication. The method may be performed by a base station (e.g., the base station 102, 504, 604, 704, 804; the network entity 1102, 1202). In some aspects, the method may include aspects described in connection with the communication flow in FIG. 5, and/or aspects described in FIGS. 4, 6, 7, 8. The method may be for calibration of synchronization signal/LP-SS measurements to utilize the synchronization signals, such as LP-SSs, for measurement purposes while a MR stays in a deep sleep mode. The method may provide for offloading measurements related to UE mobility with reduced active time of the MR to increase power savings by utilizing a low-power radio (e.g., a LP-WUR) of a UE to monitor for synchronization signal(s)/LP-SS(s), and for more efficiently enabling and performing low-power radio measurements by utilizing entry/exit criteria for a low-power radio (e.g., a LP-WUR) of a UE to perform measurements related to UE mobility.

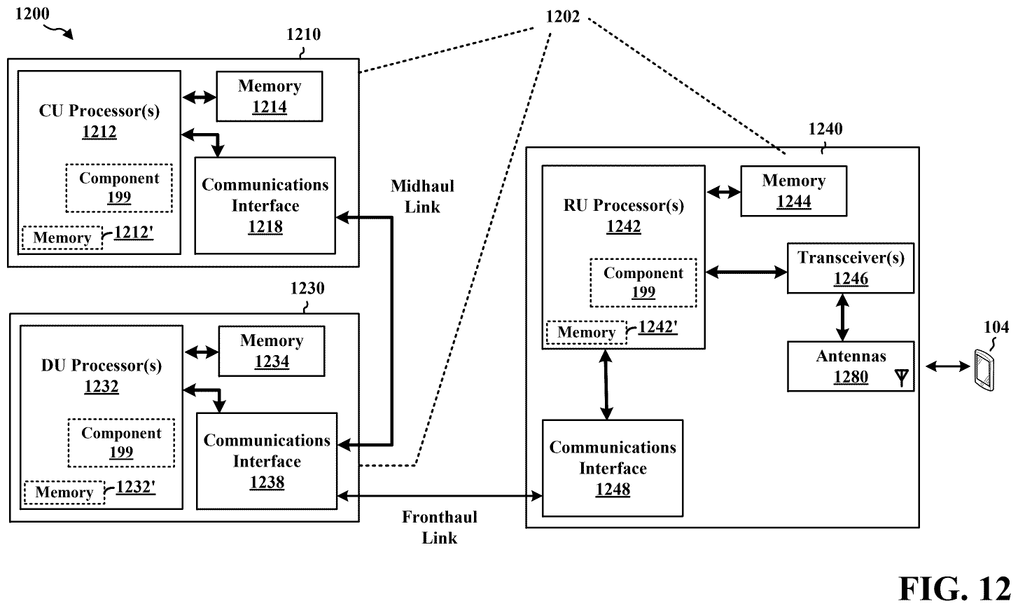

At 1002, the network node configures a UE with a calibration configuration indicative of one or more of at least one synchronization signal, a threshold condition, a measurement offset, a calibration window, a calibration trigger, or a calibration report. For example, the configuration may be performed by one or more of the component 199, the transceiver(s) 1246, and/or the antenna 1280 in FIG. 12. FIG. 5 illustrates, in the context of FIGS. 6, 7, 8, an example of a network node (e.g., the base station 504) configuring a UE (e.g., the UE 502) with such a calibration configuration.

The UE 502 may be configured to receive, and the base station 504 may be configured to transmit/provide, a calibration configuration 506 (e.g., 708 in FIG. 7) indicative of one or more of at least one synchronization signal 510 (e.g., 605 in FIG. 6; 722 in FIG. 7), a threshold condition (e.g., 710 in FIG. 7), a measurement offset (e.g., 712 in FIG. 7; 808 in FIG. 8), a calibration window (e.g., 714 in FIG. 7), a calibration trigger (e.g., 728 in FIG. 7), or a calibration report 516 (e.g., 806 in FIG. 8). In aspects, the calibration configuration 506 (e.g., 708 in FIG. 7) may be received and/or transmitted/provided, via at least one of SI or RRC signaling. In aspects, the calibration window (e.g., 714 in FIG. 7) (i) may be associated with at least one of a frequency separation, a frequency band, a frequency range, or a signal periodicity of the at least one synchronization signal 510 (e.g., 605 in FIG. 6; 722 in FIG. 7) and at least one SSB 508 (e.g., 605 in FIG. 6; 720 in FIG. 7), and (ii) may define a period of time (e.g., 716 in FIG. 7), and/or a start time (e.g., 718 in FIG. 7) thereof, associated with the at least one SSB 508 (e.g., 605 in FIG. 6; 720 in FIG. 7) for reception of the at least one synchronization signal 510 (e.g., 605 in FIG. 6; 722 in FIG. 7). In aspects, as noted above, the calibration configuration 506 (e.g., 708 in FIG. 7) may be indicative of the calibration report 516 (e.g., 806 in FIG. 8). The calibration report 516 (e.g., 806 in FIG. 8) may be indicative of at least one of a measurement difference (e.g., 612 in FIG. 6), an estimated calibration error (e.g., 616 in FIG. 6) that is based on the measurement difference (e.g., 612 in FIG. 6), a synchronization signal measurement (e.g., 608 in FIG. 6), a synchronization signal metric (e.g., 622 in FIG. 6), a SSB measurement (e.g., 608 in FIG. 6), or a SSB metric (e.g., 622 in FIG. 6). A synchronization signal metric (e.g., 622 in FIG. 6) and/or a SSB metric (e.g., 622 in FIG. 6) may be at least one of a reference signal received power (RSRP), a reference signal received quality (RSRQ), or a signal to interference and noise ratio (SINR). In some aspects, the calibration configuration 506 (e.g., 708 in FIG. 7) may be indicative of the calibration report 516 (e.g., 806 in FIG. 8) being based on at least one of a periodic reporting, a connected mode reporting, or a reporting threshold condition associated with an estimated calibration error (e.g., 616 in FIG. 6) that is based on the measurement difference (e.g., 612 in FIG. 6). In aspects, the measurement offset (e.g., 712 in FIG. 7; 808 in FIG. 8) may be based on a prior instance of the calibration report 516 (e.g., 806 in FIG. 8). The calibration trigger (e.g., 728 in FIG. 7) may be based on at least one trigger type, as described below. In one example, the calibration trigger (e.g., 728 in FIG. 7) may be a periodic calibration trigger associated with a periodicity during which identification (e.g., at 610 in FIG. 6) of the measurement difference (e.g., 612 in FIG. 6) and determination of the synchronization signal measurement (e.g., 608 in FIG. 6) are performed at least one time. As another example, the calibration trigger (e.g., 728 in FIG. 7) may be a timer-based calibration trigger associated with a timer at an expiration of which the identification (e.g., at 610 in FIG. 6) of the measurement difference (e.g., 612 in FIG. 6) and the determination of the synchronization signal measurement (e.g., 608 in FIG. 6) are performed, where a reset of the timer may be based on a wake up associated with the UE 502 when the timer is active. As a further example, the calibration trigger (e.g., 728 in FIG. 7) may be an indication-based calibration trigger associated with a wake-up signal indication, where the SSB measurement (e.g., 608 in FIG. 6) may be associated with the UE 502 being in a connected mode.

At 1004, the network node transmits, for the UE, the at least one synchronization signal in accordance with the calibration configuration and at least one SSB. For example, the transmission(s) may be performed by one or more of the component 199, the transceiver(s) 1246, and/or the antenna 1280 in FIG. 12. FIG. 5 illustrates, in the context of FIGS. 6, 7, 8, an example of a network node (e.g., the base station 504) transmitting such a synchronization signal(s) and SSB(s) to a UE (e.g., the UE 502).

The UE 502 may be configured to receive, and the base station 504 may be configured to transmit/provide, the at least one SSB 508 (e.g., 605 in FIG. 6; 720 in FIG. 7). In aspects, the UE 502 may be configured to receive the at least one SSB 508 (e.g., 605 in FIG. 6; 720 in FIG. 7) from the at least one network node (e.g., the base station 504 and another base station, where the at least one network node may be a serving cell and/or a neighbor cell(s)) via a second radio of the UE 502, such as a MR (e.g., at 724 in FIG. 7) of the UE 502. The UE 502 may be configured to receive, and the base station 504 may be configured to transmit/provide, at least one synchronization signal 510 (e.g., 605 in FIG. 6; 722 in FIG. 7). That is, the UE 502 may be configured to receive at least one synchronization signal 510 (e.g., 605 in FIG. 6; 722 in FIG. 7) from at least one network node (e.g., the base station 504 and another base station), respectively, where the at least one network node may be a serving cell and/or a neighbor cell(s). The UE 502 may be configured to receive the at least one synchronization signal 510 (e.g., 605 in FIG. 6; 722 in FIG. 7) from the at least one network node (e.g., the base station 504 and another base station, where the at least one network node may be a serving cell and/or a neighbor cell(s)) via a first radio of the UE 502, such as a low-power radio or a LP-WUR (e.g., at 726 in FIG. 7) of the UE 502. The at least one synchronization signal 510 (e.g., 605 in FIG. 6; 722 in FIG. 7) may include at least one LP-SS, PSS, SSS, SSB, and/or the like. In aspects, the UE 502 may be configured to receive the at least one synchronization signal 510 (e.g., 605 in FIG. 6; 722 in FIG. 7) during a calibration window (e.g., 714 in FIG. 7) having a start time (e.g., 718 in FIG. 7) and a period (e.g., 716 in FIG. 7), in accordance with the calibration configuration 506 (e.g., 708 in FIG. 7).

At 1006, the network node receive, from the UE, the calibration report in accordance with the calibration configuration, where the calibration report is indicative of at least one of a measurement difference, a synchronization signal measurement, a synchronization signal metric, an SSB measurement, or an SSB metric, where the measurement difference is between the synchronization signal metric that is associated with the synchronization signal measurement and the SSB metric that is associated with the SSB measurement. For example, the reception may be performed by one or more of the component 199, the transceiver(s) 1246, and/or the antenna 1280 in FIG. 12. FIG. 5 illustrates, in the context of FIGS. 6, 7, 8, an example of a network node (e.g., the base station 504) receiving such a calibration report from a UE (e.g., the UE 502).

The UE 502 may be configured to identify (at 512) (e.g., at 610 in FIG. 6) the measurement difference (e.g., 612 in FIG. 6) between the synchronization signal metric (e.g., 622 in FIG. 6) that may be associated with the synchronization signal measurement (e.g., 608 in FIG. 6) of the at least one synchronization signal 510 (e.g., 605 in FIG. 6; 722 in FIG. 7) and the SSB metric (e.g., 622 in FIG. 6) that may be associated with the SSB measurement (e.g., 608 in FIG. 6) of the at least one SSB 508 (e.g., 605 in FIG. 6; 720 in FIG. 7). For example, to identify (at 512) (e.g., at 610 in FIG. 6) the measurement difference (e.g., 612 in FIG. 6), the UE 502 may be configured to measure (e.g., at 606 in FIG. 6) the at least one synchronization signal 510 (e.g., 605 in FIG. 6; 722 in FIG. 7) and to obtain the synchronization signal measurement (e.g., 608 in FIG. 6) for the synchronization signal metric (e.g., 622 in FIG. 6) based on the at least one synchronization signal 510 (e.g., 605 in FIG. 6; 722 in FIG. 7) that is measured (e.g., at 606 in FIG. 6). Accordingly, the UE 502 may be configured to identify (at 512) (e.g., at 610 in FIG. 6) the measurement difference (e.g., 612 in FIG. 6) based on the obtained synchronization signal measurement (e.g., 608 in FIG. 6). The UE 502 may be configured to determine (at 514) the synchronization signal measurement (e.g., 608 in FIG. 6) based on the measurement difference (e.g., 612 in FIG. 6) that is associated with the threshold condition (e.g., 710 in FIG. 7). As used herein, to determine by a UE may mean to configure by the UE, to set by the UE, and/or the like. For example, the UE 502 may be configured to estimate (e.g., at 614 in FIG. 6) as an updated/maintained synchronization signal measurement a calibration error based on the measurement difference (e.g., 612 in FIG. 6), and to update or maintain (e.g., at 618 in FIG. 6) the synchronization signal measurement (e.g., 608 in FIG. 6) as an updated/maintained synchronization signal measurement (e.g., 620 in FIG. 6) in accordance with the estimated calibration error (e.g., 616 in FIG. 6). In aspects, the threshold condition (e.g., 710 in FIG. 7) may be associated with at least one of a first comparison of a first difference between the synchronization signal metric (e.g., 622 in FIG. 6) and the SSB metric (e.g., 622 in FIG. 6) with a threshold instance value, or a second comparison of a second difference between a first mean value of the synchronization signal metric (e.g., 622 in FIG. 6) and a second mean value of the SSB metric (e.g., 622 in FIG. 6) with a mean threshold value. In some aspects, at least one of the threshold instance value or the mean threshold value may include an addition of the measurement offset (e.g., 712 in FIG. 7; 808 in FIG. 8). The UE 502 may be configured to transmit/provide, and the base station 504 (e.g., at least one network node) may be configured to receive, the calibration report 516 (e.g., 806 in FIG. 8) in accordance with the calibration configuration 506 (e.g., 708 in FIG. 7) and/or a calibration report trigger(s) (e.g., 810 in FIG. 8). The calibration report 516 (e.g., 806 in FIG. 8) may be indicative of at least one of the measurement difference (e.g., 612 in FIG. 6), the estimated calibration error (e.g., 616 in FIG. 6) that is based on the measurement difference (e.g., 612 in FIG. 6), the synchronization signal measurement (e.g., 608 in FIG. 6), the synchronization signal metric (e.g., 622 in FIG. 6), the SSB measurement (e.g., 608 in FIG. 6), or the SSB metric (e.g., 622 in FIG. 6). The base station 504 may be configured to update or maintain (at 518) the measurement offset (e.g., 712 in FIG. 7; 808 in FIG. 8) in accordance with the calibration report 516 (e.g., 806 in FIG. 8), which may be indicated to the UE 502.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to receive at least one synchronization signal and at least one SSB from at least one network node, respectively. The component 198 may be configured to identify a measurement difference between a synchronization signal metric associated with a synchronization signal measurement of the at least one synchronization signal and a SSB metric associated with an SSB measurement of the at least one SSB. The component 198 may be configured to determine the synchronization signal measurement based on the measurement difference that is associated with a threshold condition. The component 198 may be configured to estimate a calibration error based on the measurement difference. The component 198 may be configured to update or maintain the synchronization signal measurement in accordance with the estimated calibration error. The component 198 may be configured to receive, from the at least one network node, a calibration configuration indicative of one or more of the at least one synchronization signal, the threshold condition, a measurement offset, a calibration window, a calibration trigger, or a calibration report. The component 198 may be configured to transmit, to the at least one network node, the calibration report in accordance with the calibration configuration, where the calibration report is indicative of at least one of the measurement difference, an estimated calibration error that is based on the measurement difference, the synchronization signal measurement, the synchronization signal metric, the SSB measurement, or the SSB metric. The component 198 may be configured to receive the at least one synchronization signal via a first radio of the UE and to receive the at least one SSB from the at least one network node via a second radio of the UE. The component 198 may be further configured to perform any of the aspects described in connection with the flowcharts in any of FIGS. 9, 10, and/or any of the aspects performed by a UE for any of FIGS. 4-8. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving at least one synchronization signal and at least one SSB from at least one network node, respectively. In one configuration, the apparatus 1104, and in particular the cellular baseband processor(s) 1124 and/or the application processor(s) 1106, may include means for identifying a measurement difference between a synchronization signal metric associated with a synchronization signal measurement of the at least one synchronization signal and a SSB metric associated with an SSB measurement of the at least one SSB. In one configuration, the apparatus 1104, and in particular the cellular baseband processor(s) 1124 and/or the application processor(s) 1106, may include means for determining the synchronization signal measurement based on the measurement difference that is associated with a threshold condition. In one configuration, the apparatus 1104, and in particular the cellular baseband processor(s) 1124 and/or the application processor(s) 1106, may include means for estimating a calibration error based on the measurement difference. In one configuration, the apparatus 1104, and in particular the cellular baseband processor(s) 1124 and/or the application processor(s) 1106, may include means for updating or maintaining the synchronization signal measurement in accordance with the estimated calibration error. In one configuration, the apparatus 1104, and in particular the cellular baseband processor(s) 1124 and/or the application processor(s) 1106, may include means for receiving, from the at least one network node, a calibration configuration indicative of one or more of the at least one synchronization signal, the threshold condition, a measurement offset, a calibration window, a calibration trigger, or a calibration report. In one configuration, the apparatus 1104, and in particular the cellular baseband processor(s) 1124 and/or the application processor(s) 1106, may include means for transmitting, to the at least one network node, the calibration report in accordance with the calibration configuration, where the calibration report is indicative of at least one of the measurement difference, an estimated calibration error that is based on the measurement difference, the synchronization signal measurement, the synchronization signal metric, the SSB measurement, or the SSB metric. In one configuration, the apparatus 1104, and in particular the cellular baseband processor(s) 1124 and/or the application processor(s) 1106, may include means for receiving the at least one synchronization signal via a first radio of the UE and for receiving the at least one SSB from the at least one network node via a second radio of the UE. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a UE with a calibration configuration indicative of one or more of at least one synchronization signal, a threshold condition, a measurement offset, a calibration window, a calibration trigger, or a calibration report. The component 199 may be configured to transmit, for the UE, the at least one synchronization signal in accordance with the calibration configuration and at least one SSB. The component 199 may be configured to receive, from the UE, the calibration report in accordance with the calibration configuration, where the calibration report is indicative of at least one of a measurement difference, a synchronization signal measurement, a synchronization signal metric, an SSB measurement, or an SSB metric, where the measurement difference is between the synchronization signal metric that is associated with the synchronization signal measurement and the SSB metric that is associated with the SSB measurement. The component 199 may be configured to update or maintain the measurement offset in accordance with the calibration report. The component 199 may be further configured to perform any of the aspects described in connection with the flowcharts in any of FIGS. 9, 10, and/or any of the aspects performed by a network node (e.g., a base station, a gNB, a network entity, etc.) for any of FIGS. 4-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for configuring a UE with a calibration configuration indicative of one or more of at least one synchronization signal, a threshold condition, a measurement offset, a calibration window, a calibration trigger, or a calibration report. In one configuration, the network entity 1202 may include means for transmitting, for the UE, the at least one synchronization signal in accordance with the calibration configuration and at least one SSB. In one configuration, the network entity 1202 may include means for receiving, from the UE, the calibration report in accordance with the calibration configuration, where the calibration report is indicative of at least one of a measurement difference, a synchronization signal measurement, a synchronization signal metric, an SSB measurement, or an SSB metric, where the measurement difference is between the synchronization signal metric that is associated with the synchronization signal measurement and the SSB metric that is associated with the SSB measurement. In one configuration, the network entity 1202 may include means for updating or maintaining the measurement offset in accordance with the calibration report. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

A UE may include a MR, e.g., for connected mode operations, as well as a low-power radio (or LP-WUR) for low power operations. A LP-WUR may be a simple radio receiver circuit designed to have a very low energy consumption. For instance, when there is no data to receive, the MR may be in a ULPS unless there is something to transmit, while the LP-WUR may actively monitor for LP-WUSs. When there is data to receive, the LP-WUR may receive a LP-WUS and activate the MR so that data is transmitted and received by the MR. A LP-WUS may be utilized to reduce unnecessary UE paging monitoring. For instance, a LP-WUS may be transmitted when there is paging for idle or inactive mode UEs, and if the LP-WUS is detected, the MR may be turned on, monitoring for a SSB before a PO for synchronization and then receiving the paging accordingly. If a LP-WUS is not detected, the MR may stay in deep sleep or ULPS mode for power savings without monitoring paging occasions (e.g., the MR may not monitor paging occasions in such low power modes). LP-SSs may be transmitted periodically to assist the LP-WUR with time/frequency synchronization. However, as the UE may also perform measurements for mobility purposes, such as cell-reselection, handover, etc., and the UE cannot save as much power if the MR is frequently awake to perform such RRM measurements. Current solutions lack conditions for entry to and exit from LP-WUS monitoring and operations of the LP-WUR for improved power savings. Additionally, current solutions lack procedures to relax RRM operations of a UE MR, for both serving and neighbor cell measurements, as well as procedures for UE serving cell RRM measurement to be offloaded from the MR to the LP-WUR of the UE, including the conditions utilized therefor.

Aspects herein are provided for calibration of synchronization signal/LP-SS measurements. Aspects alleviate the issues noted above by utilizing a synchronization signal such as a LP-SS for measurement purposes while the MR stays in the deep sleep mode. Aspects also offload measurements related to UE mobility with reduced active time of the MR to increase power savings by utilizing a low-power radio (e.g., a LP-WUR) of a UE to monitor for synchronization signal(s)/LP-SS(s). Aspects also more efficiently enable and perform low-power radio measurements by utilizing entry/exit criteria for a low-power radio (e.g., a LP-WUR) of a UE to perform measurements related to UE mobility.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving at least one synchronization signal and at least one synchronization signal block (SSB) from at least one network node, respectively; identifying a measurement difference between a synchronization signal metric associated with a synchronization signal measurement of the at least one synchronization signal and a SSB metric associated with an SSB measurement of the at least one SSB; and determining the synchronization signal measurement based on the measurement difference that is associated with a threshold condition.

Aspect 2 is the method of aspect 1, further comprising: estimating a calibration error based on the measurement difference; and updating or maintaining the synchronization signal measurement in accordance with the estimated calibration error.

Aspect 3 is the method of any of aspects 1 and 2, further comprising: receiving, from the at least one network node, a calibration configuration indicative of one or more of the at least one synchronization signal, the threshold condition, a measurement offset, a calibration window, a calibration trigger, or a calibration report.

Aspect 4 is the method of aspect 3, wherein receiving the at least one synchronization signal includes receiving the at least one synchronization signal during the calibration window, wherein the calibration window (i) is associated with at least one of a frequency separation, a frequency band, a frequency range, or a signal periodicity of the at least one synchronization signal and the at least one SSB and (ii) defines a period of time associated with the at least one SSB for reception of the at least one synchronization signal.

Aspect 5 is the method of aspect 3, wherein the calibration configuration is indicative of the calibration report, wherein the method further comprises: transmitting, to the at least one network node, the calibration report in accordance with the calibration configuration, wherein the calibration report is indicative of at least one of the measurement difference, an estimated calibration error that is based on the measurement difference, the synchronization signal measurement, the synchronization signal metric, the SSB measurement, or the SSB metric.

Aspect 6 is the method of aspect 5, wherein the calibration configuration is indicative of at least the calibration report as being based on at least one of a periodic reporting, a connected mode reporting, or a reporting threshold condition associated with the estimated calibration error that is based on the measurement difference.

Aspect 7 is the method of aspect 5, wherein the measurement offset is based on a prior calibration report.

Aspect 8 is the method of aspect 3, wherein the calibration trigger is at least one of: a periodic calibration trigger associated with a periodicity during which identification of the measurement difference and determination of the synchronization signal measurement are performed at least one time; a timer-based calibration trigger associated with a timer at an expiration of which the identification of the measurement difference and the determination of the synchronization signal measurement are performed, wherein a reset of the timer is based on a wake up associated with the UE when the timer is active; or an indication-based calibration trigger associated with a wake-up signal indication, wherein the SSB measurement is associated with the UE being in a connected mode.

Aspect 9 is the method of aspect 3, wherein receiving, from the at least one network node, the calibration configuration includes receiving the calibration configuration via at least one of system information or radio resource control (RRC) signaling.

Aspect 10 is the method of any of aspects 1 to 9, wherein the threshold condition is associated with at least one of: a first comparison of a first difference between the synchronization signal metric and the SSB metric with a threshold instance value; or a second comparison of a second difference between a first mean value of the synchronization signal metric and a second mean value of the SSB metric with a mean threshold value.

Aspect 11 is the method of aspect 10, wherein at least one of the threshold instance value or the mean threshold value includes an addition of the measurement offset.

Aspect 12 is the method of any of aspects 1 to 11, wherein the synchronization signal metric is at least one of a reference signal received power (RSRP), a reference signal received quality (RSRQ), or a signal to interference and noise ratio (SINR).

Aspect 13 is the method of any of aspects 1 to 12, wherein identifying the measurement difference includes: measuring the at least one synchronization signal; obtaining the synchronization signal measurement for the synchronization signal metric based on the measured at least one synchronization signal; and identifying the measurement difference based on the obtained synchronization signal measurement.

Aspect 14 is the method of any of aspects 1 to 13, wherein receiving the at least one synchronization signal includes receiving the at least one synchronization signal via a first radio of the UE; wherein receiving the at least one SSB from the at least one network node includes receiving the at least one SSB from the at least one network node via a second radio of the UE.

Aspect 15 is the method of aspect 14, wherein the at least one synchronization signal includes at least one low-power synchronization signal (LP-SS), wherein the first radio of the UE is at least one of a low-power radio or a low-power wake-up radio of the UE, and wherein the second radio of the UE is a main radio of the UE.

Aspect 16 is the method of any of aspects 1 to 15, wherein the at least one network node includes one or more of a first network node that is a serving cell or a second network node that is a neighbor cell.

Aspect 17 is a method of wireless communication at a network node, comprising: configuring a user equipment (UE) with a calibration configuration indicative of one or more of at least one synchronization signal, a threshold condition, a measurement offset, a calibration window, a calibration trigger, or a calibration report; transmitting, for the UE, the at least one synchronization signal in accordance with the calibration configuration and at least one synchronization signal block (SSB); and receiving, from the UE, the calibration report in accordance with the calibration configuration, wherein the calibration report is indicative of at least one of a measurement difference, a synchronization signal measurement, a synchronization signal metric, an SSB measurement, or an SSB metric, wherein the measurement difference is between the synchronization signal metric that is associated with the synchronization signal measurement and the SSB metric that is associated with the SSB measurement.

Aspect 18 is the method of aspect 17, wherein the calibration configuration is further indicative of the measurement offset of the threshold condition associated with the measurement difference; the method further comprising: updating or maintaining the measurement offset in accordance with the calibration report.

Aspect 19 is the method of any of aspects 17 and 18, wherein transmitting the at least one synchronization signal includes transmitting the at least one synchronization signal during the calibration window, wherein the calibration window (i) is associated with at least one of a frequency separation, a frequency band, a frequency range, or a signal periodicity of the at least one synchronization signal and the at least one SSB and (ii) defines a period of time associated with the at least one SSB for reception of the at least one synchronization signal; wherein the calibration configuration is indicative of the calibration report as being based on at least one of a periodic reporting, a connected mode reporting, or a reporting threshold condition associated with an estimated calibration error that is based on the measurement difference; or wherein the calibration trigger is at least one of: a periodic calibration trigger associated with a trigger periodicity during which identification of the measurement difference and determination of the synchronization signal measurement are performed at least one time; a timer-based calibration trigger associated with a timer at an expiration of which the identification of the measurement difference and the determination of the synchronization signal measurement are performed, wherein a reset of the timer is based on a wake up associated with the UE when the timer is active; or an indication-based calibration trigger associated with a wake-up signal indication, wherein the SSB measurement is associated with the UE being in a connected mode.

Aspect 20 is an apparatus for wireless communication at a user equipment (UE), comprising: at least one memory; and at least one processor coupled to the at least one memory, the at least one processor, individually or in any combination, is configured to perform the method of any of aspects 1 to 16.

Aspect 21 is an apparatus for wireless communication at a user equipment (UE), comprising means for performing each step in the method of any of aspects 1 to 16.

Aspect 22 is the apparatus of any of aspects 20 to 21, further comprising a transceiver configured to receive or to transmit in association with the method of any of aspects 1 to 16.

Aspect 23 is a computer-readable medium (e.g., a non-transitory computer-readable medium) storing computer executable code at a user equipment (UE), the code when executed by at least one processor causes the at least one processor to perform the method of any of aspects 1 to 16.

Aspect 24 is an apparatus for wireless communication at network node, comprising: at least one memory; and at least one processor coupled to the at least one memory, the at least one processor, individually or in any combination, is configured to perform the method of any of aspects 17 to 19.

Aspect 25 is an apparatus for wireless communication at network node, comprising means for performing each step in the method of any of aspects 17 to 19.

Aspect 26 is the apparatus of any of aspects 24 to 25, further comprising a transceiver configured to receive or to transmit in association with the method of any of aspects 17 to 19.

Aspect 27 is a computer-readable medium (e.g., a non-transitory computer-readable medium) storing computer executable code at network node, the code when executed by at least one processor causes the at least one processor to perform the method of any of aspects 17 to 19.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive at least one synchronization signal and at least one synchronization signal block (SSB) from at least one network node, respectively;
identify a measurement difference between a synchronization signal metric associated with a synchronization signal measurement of the at least one synchronization signal and a SSB metric associated with an SSB measurement of the at least one SSB; and
determine the synchronization signal measurement based on the measurement difference that is associated with a threshold condition.

2. The apparatus of claim 1, wherein the at least one processor, individually or in any combination, is further configured to:
estimate a calibration error based on the measurement difference; and
update or maintain the synchronization signal measurement in accordance with the estimated calibration error.

3. The apparatus of claim 1, wherein the at least one processor, individually or in any combination, is further configured to:
receive, from the at least one network node, a calibration configuration indicative of one or more of the at least one synchronization signal, the threshold condition, a measurement offset, a calibration window, a calibration trigger, or a calibration report.

4. The apparatus of claim 3, wherein to receive the at least one synchronization signal, the at least one processor, individually or in any combination, is configured to receive the at least one synchronization signal during the calibration window, wherein the calibration window (i) is associated with at least one of a frequency separation, a frequency band, a frequency range, or a signal periodicity of the at least one synchronization signal and the at least one SSB and (ii) defines a period of time associated with the at least one SSB for reception of the at least one synchronization signal.

5. The apparatus of claim 3, further comprising at least one transceiver coupled to the at least one processor, wherein the calibration configuration is indicative of the calibration report, wherein the at least one processor, individually or in any combination, is further configured to:
transmit, to the at least one network node and via the at least one transceiver, the calibration report in accordance with the calibration configuration, wherein the calibration report is indicative of at least one of the measurement difference, an estimated calibration error that is based on the measurement difference, the synchronization signal measurement, the synchronization signal metric, the SSB measurement, or the SSB metric.

6. The apparatus of claim 5, wherein the calibration configuration is indicative of at least the calibration report as being based on at least one of a periodic reporting, a connected mode reporting, or a reporting threshold condition associated with the estimated calibration error that is based on the measurement difference.

7. The apparatus of claim 5, wherein the measurement offset is based on a prior calibration report.

8. The apparatus of claim 3, wherein the calibration trigger is at least one of:
a periodic calibration trigger associated with a periodicity during which identification of the measurement difference and determination of the synchronization signal measurement are performed at least one time;
a timer-based calibration trigger associated with a timer at an expiration of which the identification of the measurement difference and the determination of the synchronization signal measurement are performed, wherein a reset of the timer is based on a wake up associated with the UE when the timer is active; or
an indication-based calibration trigger associated with a wake-up signal indication, wherein the SSB measurement is associated with the UE being in a connected mode.

9. The apparatus of claim 3, wherein to receive, from the at least one network node, the calibration configuration, the at least one processor, individually or in any combination, is configured to receive the calibration configuration via at least one of system information or radio resource control (RRC) signaling.

10. The apparatus of claim 1, wherein the threshold condition is associated with at least one of:
a first comparison of a first difference between the synchronization signal metric and the SSB metric with a threshold instance value; or
a second comparison of a second difference between a first mean value of the synchronization signal metric and a second mean value of the SSB metric with a mean threshold value.

11. The apparatus of claim 10, wherein at least one of the threshold instance value or the mean threshold value includes an addition of a measurement offset.

12. The apparatus of claim 1, wherein the synchronization signal metric is at least one of a reference signal received power (RSRP), a reference signal received quality (RSRQ), or a signal to interference and noise ratio (SINR).

13. The apparatus of claim 1, wherein to identify the measurement difference, the at least one processor, individually or in any combination, is configured to:
measure the at least one synchronization signal;
obtain the synchronization signal measurement for the synchronization signal metric based on the measured at least one synchronization signal; and
identify the measurement difference based on the obtained synchronization signal measurement.

14. The apparatus of claim 1, wherein to receive the at least one synchronization signal, the at least one processor, individually or in any combination, is configured to receive the at least one synchronization signal via a first radio of the UE;
wherein to receive the at least one SSB, the at least one processor, individually or in any combination, is configured to receive the at least one SSB from the at least one network node via a second radio of the UE.

15. The apparatus of claim 14, wherein the at least one synchronization signal includes at least one low-power synchronization signal (LP-SS), wherein the first radio of the UE is at least one of a low-power radio or a low-power wake-up radio of the UE, and wherein the second radio of the UE is a main radio of the UE.

16. The apparatus of claim 1, wherein the at least one network node includes one or more of a first network node that is a serving cell or a second network node that is a neighbor cell.

17. An apparatus for wireless communication at a network node, comprising:
at least one memory; and
at least one processor coupled to the at least one memory and, based at least in part on information stored in the at least one memory, the at least one processor, individually or in any combination, is configured to:
configure a user equipment (UE) with a calibration configuration indicative of one or more of at least one synchronization signal, a threshold condition, a measurement offset, a calibration window, a calibration trigger, or a calibration report;
transmit, for the UE, the at least one synchronization signal in accordance with the calibration configuration and at least one synchronization signal block (SSB); and
receive, from the UE, the calibration report in accordance with the calibration configuration, wherein the calibration report is indicative of at least one of a measurement difference, a synchronization signal measurement, a synchronization signal metric, an SSB measurement, or an SSB metric, wherein the measurement difference is between the synchronization signal metric that is associated with the synchronization signal measurement and the SSB metric that is associated with the SSB measurement.

18. The apparatus of claim 17, wherein the calibration configuration is further indicative of the measurement offset of the threshold condition associated with the measurement difference;
wherein the at least one processor, individually or in any combination, is further configured to:
update or maintain the measurement offset in accordance with the calibration report.

19. The apparatus of claim 17, wherein to transmit the at least one synchronization signal, the at least one processor, individually or in any combination, is configured to transmit the at least one synchronization signal during the calibration window, wherein the calibration window (i) is associated with at least one of a frequency separation, a frequency band, a frequency range, or a signal periodicity of the at least one synchronization signal and the at least one SSB and (ii) defines a period of time associated with the at least one SSB for reception of the at least one synchronization signal;
wherein the calibration configuration is indicative of the calibration report as being based on at least one of a periodic reporting, a connected mode reporting, or a reporting threshold condition associated with an estimated calibration error that is based on the measurement difference; or
wherein the calibration trigger is at least one of:
a periodic calibration trigger associated with a trigger periodicity during which identification of the measurement difference and determination of the synchronization signal measurement are performed at least one time;
a timer-based calibration trigger associated with a timer at an expiration of which the identification of the measurement difference and the determination of the synchronization signal measurement are performed, wherein a reset of the timer is based on a wake up associated with the UE when the timer is active; or
an indication-based calibration trigger associated with a wake-up signal indication, wherein the SSB measurement is associated with the UE being in a connected mode.

20. A method of wireless communication at a user equipment (UE), comprising:
receiving at least one synchronization signal and at least one synchronization signal block (SSB) from at least one network node, respectively;
identifying a measurement difference between a synchronization signal metric associated with a synchronization signal measurement of the at least one synchronization signal and a SSB metric associated with an SSB measurement of the at least one SSB; and
determining the synchronization signal measurement based on the measurement difference that is associated with a threshold condition.
